(19) United States
(12) Patent Application Publication
(10) Pub. No.: US 2020/0133829 A1
(43) Pub. Date: Apr. 30, 2020

(54) METHODS AND SYSTEMS FOR PERFORMANCE TESTING

(71) Applicant: SmartBear Software Inc., Somerville, MA (US)

(72) Inventors: Pedro Abraham Nevado Zazo, Parkland, FL (US); Anand R. Sundaram, Cambridge, MA (US); Sapna Natarajan, Boca Raton, FL (US)

(21) Appl. No.: 16/663,884

(22) Filed: Oct. 25, 2019

Related U.S. Application Data
(60) Provisional application No. 62/751,360, filed on Oct. 26, 2018.

(51) Int. Cl. G06F 11/36; G06F 11/34

(52) U.S. Cl. CPC G06F 11/3688; G06F 11/3692; G06F 11/3433; G06F 11/3457; G06F 11/3414

(57) ABSTRACT

A method includes executing a web-based application within a first browser, executing and displaying a second browser inside of the web-based application, receiving, via the second browser, data indicative of one or more inputs including a browser session and recording and storing the one or more inputs on a computer readable medium.

### CLAIM OF PRIORITY

This application claims priority to U.S. Provisional No. 62/751,360 (Attorney Docket No. SBAR-0001-P01), entitled “METHODS AND SYSTEMS FOR PERFORMANCE TESTING,” filed Oct. 26, 2018, which is hereby incorporated by reference in its entirety as if fully set forth herein.

### BACKGROUND

### Field

The methods and systems described herein generally relate to system and stress testing for the performance evaluation of web-based web applications.

### Description of the Related Art

Performance testing refers to an overall umbrella of functions that govern all aspects of understanding the behavior of a computer system under various conditions of usage or load.

The primary goal of performance testing is to understand the performance of the system under various conditions of load, understand how the system is able to sustain over increased usage, understand its outside limits and what causes things to break, understand how the system behaves and possibly degrades when under stress for a continuous period of time, and ensure that when a system's performance deteriorates or components that make up the application/system break, the system performance degrades gracefully, does not render the application unusable for all users and that it provides enough information about the problems to a user so that he/she can decide what to do next.

Performance testing is typically broken down into various areas including load testing, stress testing, soak testing, spike testing and volume testing.

Load testing involves ramping up and running a computational load on a computer over a period of time and checking to see how response time degrades over time as well as correlate response times with server side metrics to identify bottlenecks. In general, the goal is also to create a benchmark and compare it across versions of the applications. For example, a load on a server may be ramped up while end user response time is observed as it degrades. In parallel, one may observe the performance of various server components to look for component degradation that is proportional to the ramped up client activity.

Stress testing seeks to understand how a system behaves under extreme loads to see if it crashes spectacularly, if it degrades gracefully and if it has the ability to recover. Stress testing is often referred to as endurance testing and/or fatigue testing and typically involves a high volume of computational load over short periods of time.

Soak testing seeks to ramp up and keep a system under a load for a long period of time to see how performance degrades over time while spike testing seeks to ramp up a load suddenly to see if all portions of the system can handle sudden demands on the system. Lastly, volume testing operates to see how a system handles large volumes of data and can be used for applications by simulating user behavior that results in large volumes of data being processed and checked for efficiency.

Traditional performance testing systems utilize a protocol recorder to record and play back web applications. Such systems sniff the traffic that comprises the interaction between the browser (client) and the web server when a user interacts with the application under test. This traffic is recorded as the output or the recorded script.

This script may be immediately fixed up for it to be played back. This includes programming to replicate client side dynamic behavior and the correlation of dynamic characteristics of the web application. Conventional protocol based recorders suffer from an enormous amount of time being spent on the fixing and/or creating of load test scripts rather than load testing the app and working on the performance of the web application. Typically, recording is tedious and requires a good deal of massaging before a recording may be used in a load test. For example, a single recording may need to be altered repeatedly so that a server hosting a web site does not interpret the recording as a web bot or the same browser session being submitted repeatedly.

Next, system load is generated using proprietary load generators. Specifically, traditional platforms have their own version of a browser which replays the recorded script and pretends to be a real browser. These load generators are what place the web server under stress when a load test is performed. However, the load that is placed on the system with, for example, 100 virtual users using the proprietary load generators, is an approximation of the load that the application will see when there are 100 real users using the system.

Some products allow a small amount of load to be generated with real browsers so that one can see what the end user experience would be like under the load. In such instances one records a type of script distinctly different than the script recorder from the protocol. In such instances, the performance data that is generated is not the same as what browsers typically report when it comes to end user experience or web application navigation timings. Further, traditional platforms don't allow one to connect to the virtual users—the load generators—to see what they are doing in real time. Lastly, when errors occur, they are reported and collected and one does not typically have the ability to interact with the virtual users that generate the load.

Further, the performance data that is created by these conventional systems is not what developers and performance testers typically want. Load testing tools return request-response times in test results, which need to be further inspected and deciphered in order to be usable by developers and performance testers.

What is needed is performance testing platform that does not exhibit the deficiencies in traditional systems as described above.

### SUMMARY

In accordance with an exemplary and non-limiting embodiment, a method comprises executing a web-based application within a first browser, executing and displaying a second browser inside of the web-based application, receiving, via the second browser, data indicative of one or more inputs comprising a browser session and recording and storing the one or more inputs on a computer readable medium. In accordance with an exemplary and non-limiting embodiment, the method may further comprise utilizing the stored one or more inputs to simulate a load on a server. In accordance with another exemplary and non-limiting embodiment, utilizing the stored one or more inputs comprises replaying the stored one or more inputs as inputs to the server at a predetermined scale. In accordance with another exemplary and non-limiting embodiment, replaying the stored one or more inputs comprises running a plurality of browsers in a headless mode. In accordance with another exemplary and non-limiting embodiment, the method further comprises receiving an indication that replaying the stored one or more inputs has generated an error. In accordance with another exemplary and non-limiting embodiment, the method further comprises upon receiving the indication, replaying of the stored one or more inputs is suspended. In accordance with another exemplary and non-limiting embodiment, replaying of the stored one or more inputs is suspended for a predetermined amount of time.

In accordance with an exemplary and non-limiting embodiment, a method comprises recording and storing on a computer readable medium data indicative of one or more inputs comprising a browser session of a user executing on a client device, replaying the stored one or more inputs as a plurality of virtual user sessions to the server at a predetermined scale sufficient to simulate a predefined number of virtual users based, at least in part, upon an existing server environment and inspecting, during the replaying of the one or more inputs, a single instance of one of the plurality of virtual user sessions. In accordance with an exemplary and non-limiting embodiment, the inspecting comprises observing a graphical representation of a user interface of one of the plurality of virtual user sessions.

In accordance with an exemplary and non-limiting embodiment, a system comprises a non-transient computer readable medium storing instructions that when executed by a processor cause the processor to execute a web-based application within a first browser, execute and displaying a second browser inside of the web-based application, receive, via the second browser, data indicative of one or more inputs comprising a browser session and record and store the one or more inputs on a computer readable medium. In accordance with an exemplary and non-limiting embodiment, the processor is further configured to utilize the stored one or more inputs to simulate a load on a server. In accordance with an exemplary and non-limiting embodiment, utilizing the stored one or more inputs comprises replaying the stored one or more inputs as inputs to the server at a predetermined scale. In accordance with an exemplary and non-limiting embodiment, replaying the stored one or more inputs comprises running a plurality of browsers in a headless mode. In accordance with an exemplary and non-limiting embodiment, the processor is further configured to receive an indication that replaying the stored one or more inputs has generated an error. In accordance with an exemplary and non-limiting embodiment the processor is further configured to, upon receiving the indication, replay of the stored one or more inputs is suspended. In accordance with an exemplary and non-limiting embodiment, replaying of the stored one or more inputs is suspended for a predetermined amount of time.

In accordance with an exemplary and non-limiting embodiment, a system comprises a non-transient computer readable medium storing instructions that when executed by a processor cause the processor to record and store on a computer readable medium data indicative of one or more inputs comprising a browser session of a user executing on a client device, replay the stored one or more inputs as a plurality of virtual user sessions to the server at a predetermined scale sufficient to simulate a predefined number of virtual users based, at least in part, upon an existing server environment and inspect, during the replaying of the one or more inputs, a single instance of one of the plurality of virtual user sessions. In accordance with an exemplary and non-limiting embodiment, the inspecting comprises observing a graphical representation of a user interface of one of the plurality of virtual user sessions.

### DESCRIPTION OF THE DRAWINGS

FIG. 1 depicts an exemplary and non-limiting embodiment of a performance testing platform.

FIG. 2 depicts an exemplary and non-limiting embodiment of a schematic diagram of a recorder.

FIG. 3 depicts an exemplary and non-limiting embodiment of a virtual user inspector.

FIG. 4 depicts an exemplary and non-limiting embodiment of various virtual users such as may be utilized to generate a load.

FIG. 5 depicts an exemplary and non-limiting embodiment of a schematic diagram of a real time debugger.

FIG. 6 depicts an exemplary and non-limiting embodiment of navigation timings.

FIG. 7 depicts an exemplary and non-limiting architecture embodiment.

FIG. 8 depicts an exemplary and non-limiting embodiment of a use case.

### DETAILED DESCRIPTION

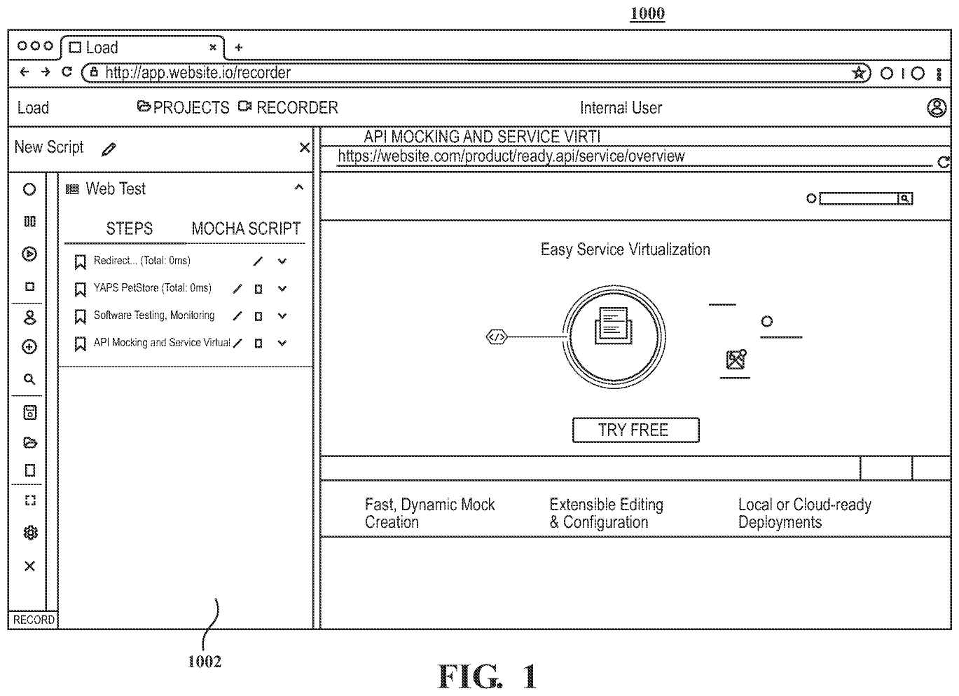

In accordance with exemplary and non-limiting embodiments, a performance testing platform comprises an embedded browser to record load traffic. With reference to FIG. 1, there is illustrated a performance testing platform 1000 comprising a web application that enables user interaction via a web browser. In some embodiments, the load testing web application is a Software as a Service (SaaS) app that is rendered in a browser. As illustrated, a recorder uses a browser 1002 that is rendered inside of an app which is a web app.

For a load test to be performed, the testers will often find pathways of the application that are to be used for the load test. For example, in a banking app, 70% of the users check balances, 20% pay bills, 5% transfer money and another 5% make changes to their profiles. The first thing that end user or tester may do is record the pathways for the above usage scenarios (e.g., login, go through he steps to check balances, and logout).

They may then play it back to make sure that what they have captured can be played back. This is where most tools get tripped up and users spend a lot of time fixing the recorded script before it can be played back or replayed. They configure a load test which uses the recorded usages through the applications and then specify the total load that is to be placed (e.g., 10,000 concurrent users) and then break this up into three buckets based on usage patterns or guestimates (e.g., 7000 do check balances, 1500 pay bills, etc.). Next, the duration of the load test is specified and the 10K users are started in some sequence and ramped up to show concurrent usage. Each of the recorded scripts is played back over and over again using a proprietary load generator which is their rendition of a browser. The platform is then observed for degradation of the back end tiers and components and the load test tool also provides feedback on how long the entire script (check balances), and each step of the script (login, click on home page, check on balances, select your account from a few you have and review balances, and then logout) takes to execute and how things slow down as more load/more users are placed on the application under test.

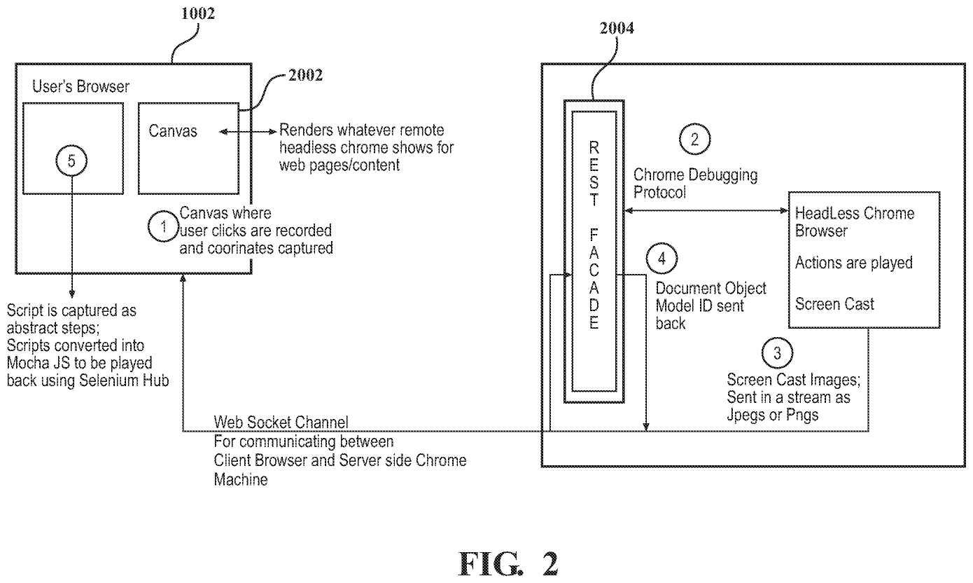

Specifically, a recorder is embedded inside the web app which is another browser inside the app rendered in the browser. As illustrated below with reference to FIG. 2, a web browser 1002 operates to implement a first web application through which a user may interact with the platform. An end user's test application may be rendered in region 2002 as an additional application within the first application. As a result, the user may navigate to their web app using the real web browser 2002 that is embedded in the web application to record an interaction with the application under test. One advantage of this functionality is the ability to capture load that occurs only on the client side but which does not affect the load on the server. There may be no element of load during this process and the goal may be to capture an end user's interaction for subsequent reuse during a load test.

For example, one may capture the interaction of the user's actions not at the protocol level but at the level of objects of the DOM (documents objects model). This ability insulates one from the problems of having to fix a recorded script as described earlier with conventional tools, and as a result the recorder script can immediately be played back.

In addition, during playback, if a web page element has changed, the platform may employ a taxonomy of UI elements and heuristics to determine a user action for simulated input. The use of object level recording in a number of cases insulates one from certain types of changes made to the web application. This is because even if the object moved around such as when, for example, the login button was moved to after the cancel button instead of before, one may use heuristics to find it.

There is no one strategy utilized to locate elements on different pages. Hence the platform may utilize a heuristic approach with fallback mechanisms to best locate an element on a page. This approach combines different search mechanisms including, but not limited to, named attributes, relative XML Path Language (XPath), Cascading Style Sheets (CSS) Selector, Absolute XPath and element coordinates.

The heuristic may use the most robust approach as the initial search mechanism. If that fails, then it may use the less robust mechanism until the element is located. The most robust approach for locating an element may be the named attribute approach that uses unique identifier's such as “id” or “name” attribute, if present. In the absence of unique identifiers, the search uses the next best approach which is the relative XPath to locate the element. The relative XPath methodology identifies a nearest parent with named attributes (“id”/“name”) and references the element from that parent. If this approach fails, then the CSS Selector which uses the element type (class/id), attribute/attribute values, and pseudo classes may be used. The next fallback mechanism is Absolute XPath which is the full XPath of the element starting from the root node. If all these methods fail, the final search mechanism may use the absolute coordinates of the element on the page to locate it.

With reference to FIG. 2, there is illustrated an exemplary and non-limiting embodiment of a schematic diagram of a recorder as described herein. As illustrated, at step 1, an HTML canvas 2002 is created in an app. The canvas records physical coordinates and mouse, as well as other input device, actions over it or in connection with it and sends these row actions to a server side. In embodiments, particular math linear transforms are applied to coordinates including the relation between canvas size and actual virtual screen size on a remote browser.

At step 2, in the REST FACADE the raw actions the user made are received such as, for example, via a WebSocket channel established between the user's browser and the facade itself. These actions may be executed in the headless browser using, for example, GOOGLE™ Chrome Debug Protocol. A headless browser is a web browser without a graphical user interface. Headless browsers provide automated control of a web page in an environment similar to popular web browsers, but are executed via a command-line interface or using network communication. They are particularly useful for testing web pages as they are able to render and understand HTML the same way a browser would, including styling elements such as page layout, color, font selection and execution of JavaScript and AJAX which are usually not available when using other testing methods. While described throughout with reference in particular to headless Chrome (interchangeably referred to as “Chrome”), any headless browser may be utilized and may be associated with a debug protocol.

At step 3, the facade is notified every time a new image is ready on the headless browser and it sends it back to the user's browser where it is painted. On this particular step, user actions performed on a browser may mean graphical changes, and those are sent to the canvas. While illustrated as step 3, in operation there exists a Step 0 where a screen cast has been started using a browser Debug Protocol as well.

At step 4, using a browser debug protocol, one identifies the DOM id, or any other DOM related expression, based on CSS selectors, Object IDs and different XML Path Language (XPATH) routes to identify such elements are computed and sent back to user's browser.

Lastly, at step 5, on the user's browser one has a full map where not only raw actions like click on coordinate X,Y, but also which is the logical component DOM wise, the user was interacting with. The sequence of all those steps are stored as an abstract script representation that then can be converted to specific scripts languages like Mocha/Selenium based scripts.

In accordance with exemplary and non-limiting embodiments, the platform utilizes real browsers at scale and to generate a true load. As noted above, traditional platforms use a proprietary load generator to emulate a browser's behavior and play back the script that is based on the protocol communication between the browser and the server. Some tools generate a small amount of load using real browsers but use their home grown protocol based load generators to generate most of the load on the platform or system under test (e.g., 90%).

The present platform operates to generate a load using real browsers. So, if a customer wishes to generate load of 10,000 concurrent users, the present platform uses 10,000 real browsers to generate the load against the application under test. In contrast to traditional platforms, the load generated by the platform is “true” and can be nearly exactly or exactly what the application would see in real life.

Traditional approaches use proprietary load generators and represent an approximation (as their load generators are pretending to be browsers and are the vendor's representation of the behavior and functionality of a browser). In contrast, the platform makes use of web services, such as, for example, AMAZON WEB SERVICES® (AWS), capacity and the ability to spin up concurrent machine images such as, for example, AMAZON MACHINE IMAGES® (AMIs). A headless browser and accompanying Debug Protocol may aid in web page diagnosis and enabling the running of load tests at scale.

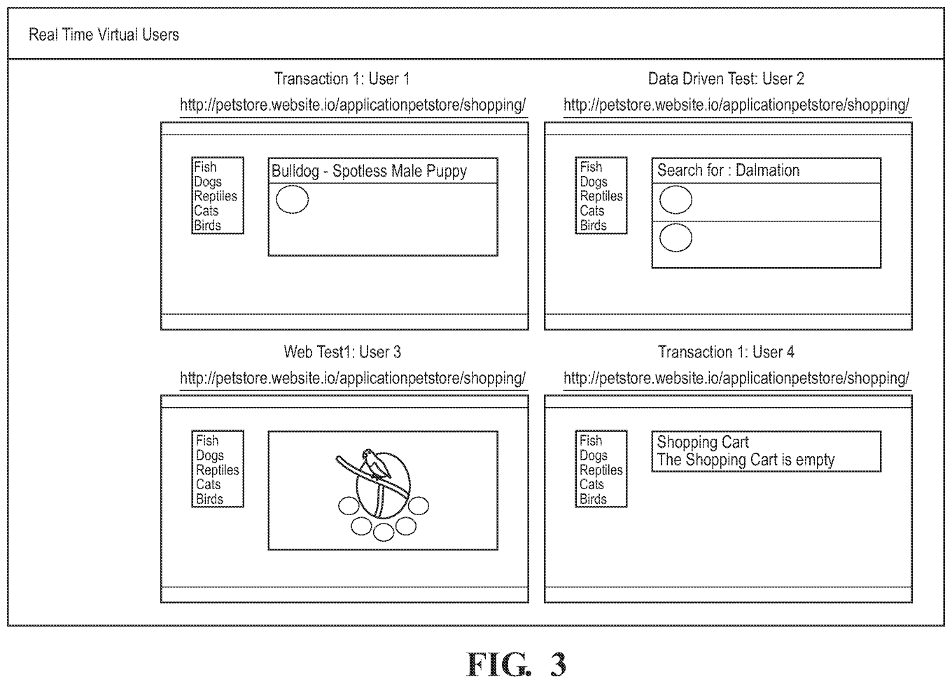

In accordance with exemplary and non-limiting embodiments and as illustrated in FIG. 3, the platform provides a virtual user inspector that allows one to see what virtual users are doing. Traditional platforms don't allow one to see or visualize what virtual users are doing. Because traditional platforms use proprietary load generators, they don't have the ability to show what each virtual user is doing in real time.

Because the present platform generates load using real browsers, there is provided a capability called the VU inspector that shows one what the load generating browsers are doing and what the pages look like as they are playing back each script. The load is generated load by running browsers without the UI or Head, in what is called headless mode. Progress is shown by connecting a head to the headless browser.

As illustrated, each of the four frames depicts a browser that is running one of the scripts. Each script depicts a user's interaction with the application that is being performance tested. For example, a frame may depict someone logging into a banking application and logging in and checking balances and logging out. At any moment there may be a large plurality of concurrent scripts depicting various user interactions running in parallel. The VU Inspector may present a randomly chosen executing script picked with a UI attached to it so that the testers can see how quickly or slowly the scripts are progressing through the application and can visually see degradation.

As noted, each of the frames represents a script depicting a user transaction forming a part of a load test. In some instances, the end user may be interested in seeing how a particular concurrent user is doing and the platform is enabled to visually display to the user the progress of the particular concurrent user.

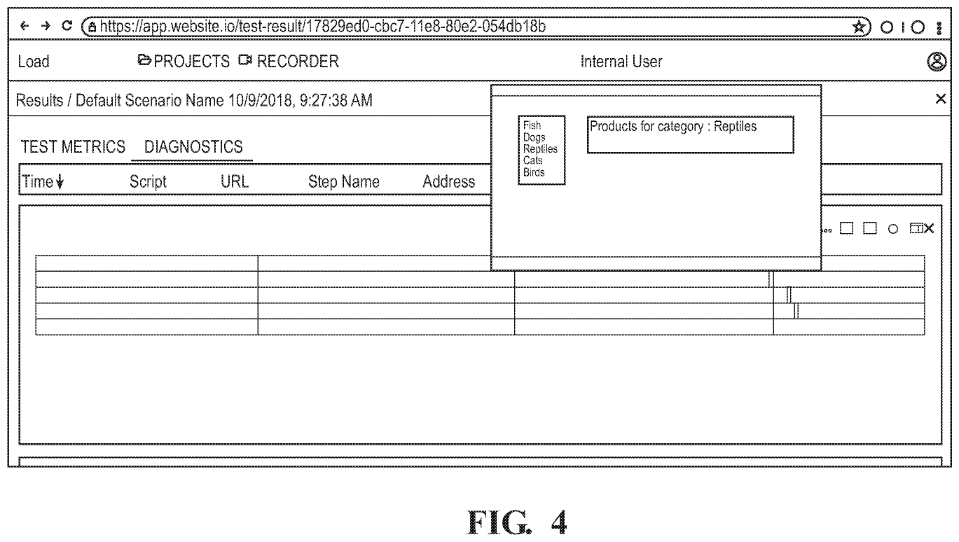

With reference to FIG. 4, there is illustrated an exemplary and non-limiting embodiment of various virtual users such as may be utilized to generate a load.

In embodiments, virtual users may generate a load against the application under test. Typically under load, the application generates errors as it is not able to sustain the load generated by concurrent (virtual) users. As a result virtual users generate errors.

Traditional platforms allow for diagnostics comprising the ability to query discrete requests to a server platform and to receive information indicative of the data returned from the server platform in response thereto. Such platforms do not provide the ability for one to connect to these virtual users of the platform in real time and to debug the user's interactions with the platform via a console or other user interface device in order to obtain additional information to help understand what is happening from the virtual user's perspective.

The present platform includes a Real Time Virtual User Debugger that connects one to the browser representing the virtual user that is in error, and allows one to debug and interact with the browser.

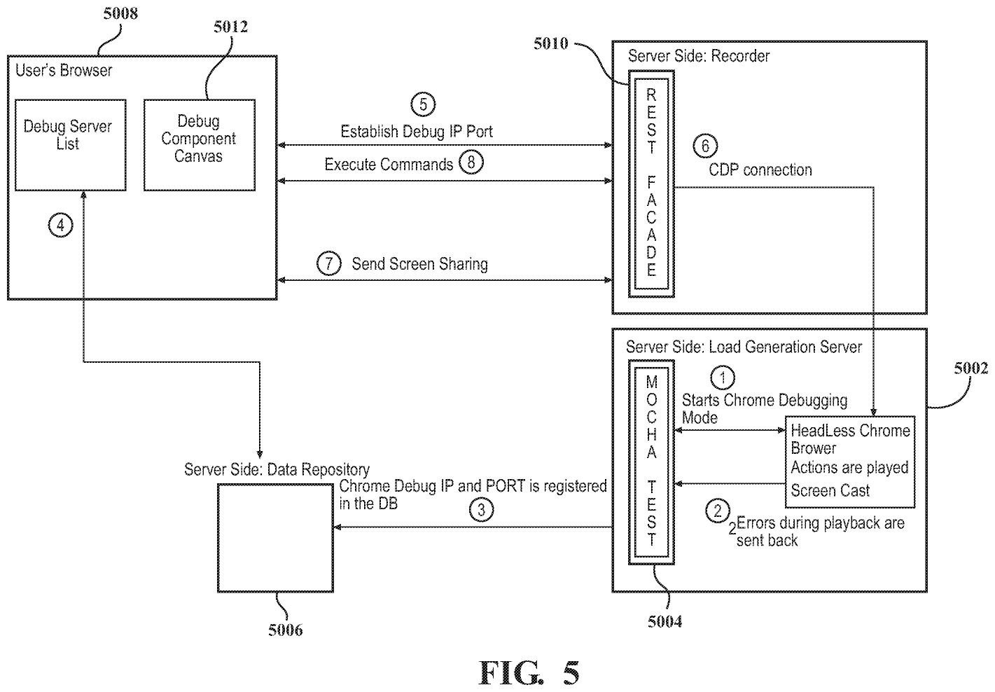

With reference to FIG. 5, there is illustrated an exemplary and non-limiting embodiment of a schematic diagram of a real time debugger of the platform.

At step 1, load generators 5002 start a browser in headless mode in addition to specifying a Debug Port to be used by each headless browser. The headless browser plays the script as instructed by the Load Generator 5002.

At step 2, when the script encounters an error, e.g., Timeout, or Validation failure, the errors are communicated back and the Mocha Test Script 5004 invokes step 3 and holds the test for a period of time (DEBUG_PERIOD) as specified in the UI when the load test was configured.

At step 3, using a remote API, the IP address and Port are added to a Central Data Repository 5006 where this erring browser in Debug Mode is reachable.

At step 4, the Web Application 5008 comprising the load testing platform on the user's browser asynchronously polls the database, and populates a list of items based on the entries it finds in the data repository of browsers (waiting in Debug mode).

At step 5, when the user clicks on the icon to view one of these browsers to debug them, a new canvas to receive images is created in a similar way to the recording mechanism. A request to start a debug session is sent to the REST FACADE 5010. This then involves the creation of an instance on another machine and the use of aforementioned REST FACADE 5010 to connect using Continuous Data Protection (CDP) to the browser waiting in debug mode.

At step 6, the Rest FACADE 5010 establishes a connection with the requested browser, with CDP, accessing to the given IP:PORT. At step 7, screen sharing is enabled and forwarded to be painted on the debug canvas 5012. At step 8, user commands and actions are sent to FACADE 5010 and, using CDP again, executed in the remote debugging browser.

Lastly, as previously illustrated at FIG. 2, once the user dismisses the debug window, the tether to the headless browser is severed and it is allowed to continue running the next iteration (as the current one is in error, it does not finish running the whole script).

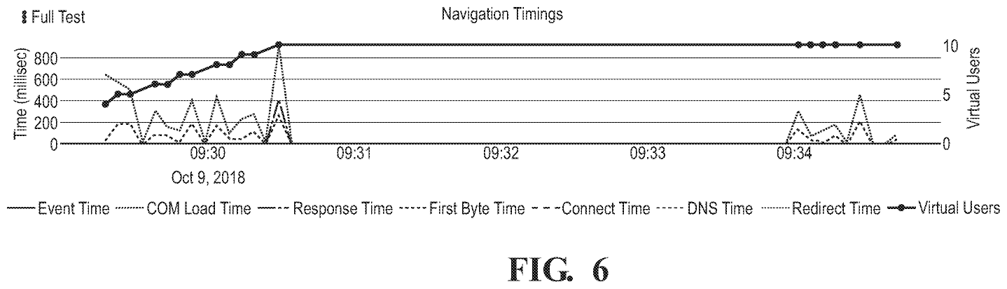

With reference to FIG. 6, there is illustrated an exemplary and non-limiting embodiment of navigation timings as are provided by the platform to allow testers and developers to quickly debug and diagnose issues.

This is in contrast to the performance and timing data that is typically produced by proprietary load generators. “Navigation Timing” is a World Wide Web Consortium (W3C) standard and is used by developers and testers to understand end user experience on the browser. The disclosed exemplary embodiments may provide Navigation Timing compliant data and hence make it easier for customers to generate load and understand the performance of their application under test.

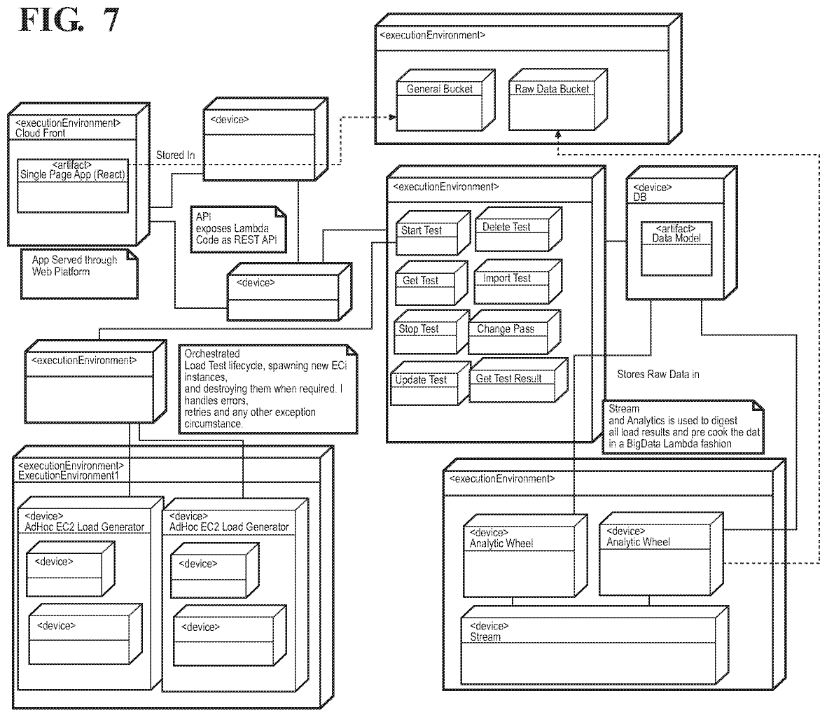

With reference to FIG. 7, there is illustrated an exemplary and non-limiting embodiment of an architecture of the platform.

A description of the operation of the Execution Environment 1 module is provide as follows. A load test may be requested by the user using the web application. In response, the LoadExecution orchestration service is summoned to run the load test. Next, a Sorting Function comprising a load distribution computing function is invoked. The load distribution computing function takes the test parameters, creates the required configuration with a view to optimize costs, and generates the required configuration which is embodied by the number of required ad hoc servers and their hardware profile.

Next, one or more required ad hoc load injector servers configured with the test capabilities may be started. All started servers may be started with the same parameters except for a server index indicator that allows each server to create different configurations.

The started servers may be mainly composed by a base Operating System, such as, for example, Selenium HUB, to mange browsers, and browsers that are started in headless mode as well as wrapping libraries used to run functional tests specified in the load test configurations. All the started servers may make a call to the orchestration system to flag themselves as ready to start a test. The servers may keep pooling in short intervals for the ‘startTest’ signal. Afterwards, this same endpoint may be invoked periodically to receive any control command.

During the load test, each browser may report metrics to a file system that is streamed to the big data streaming receptor. Once a task has been concluded, the orchestration service may be notified. The orchestration service performs clean up tasks and finally tears down ephemeral ad hoc load injectors.

In accordance with exemplary and non-limiting embodiments, the platform follows a serverless-microservices architecture. This means, possible except for a few exceptions in certain embodiments, there is no dedicated server at all. Broadly speaking the platform comprises the following components:
Lambda functions, where most of the business logic is encapsulated.
API Gateway that provides a RESTful interface for the lambda functions.
A module that coordinates the microservices implemented by some of the lambda functions and embodies the stateful side of a running load test (for example, AMAZON STEP®).
A main data store (for example, DYNAMODB®).
A basic Identity Provider (IDP) (for example, COGNITO®).
A single page app that embodies the UI (for example, React App).
Additional services (for example, CLOUDFRONT®, S3, etc.) may be used to provide a multi-availability web application.
load generator's AMIs to generate load and perform ad hoc spanning of cloud computing platforms (for example, AMAZON ELASTIC COMPUTE CLOUD® (AMAZON EC2®)).
A data stream (for example, AMAZON KINESIS DATA STREAM® may used to stream the data load results from servers to an analytics stage.
A data analytics module (for example, AMAZON KINESIS DATA ANALYTICS®) may summarize the un-aggregated streamed data and may output the “cooked” information that is stored into a database via the invocation of the proper Lambda Functions.
A common language (for example CloudFormation) may be used to consolidate all the architectural details as code, so the environment achieves consistency and can be easily replicated.

With further reference to FIG. 7, the web layer may be based on a content delivery network (CDN) service such as, for example, AMAZON CLOUD FRONT®+S3. A single page application deployed in the CDN's buckets may be replicated geographically to all of the component nodes in order to speed loading times, including local caching. Further, the web layer may consume dynamic components invoking API driven architecture. APIs may be exposed using a web service and encapsulated as Lambda code, embodying serverless architecture. User management and user third party integration may be achieved leveraging web services, allowing a seamless integration with a service that enables the creation, publishing, maintenance, monitoring, and securing APIs. Ephemeral servers may be used to allocate a specific customer's load engine, using, for example, AMAZON EC2 AMI®.

Data may be consumed and digested using, for example, AMAZON KINESIS® components. A component, such as, for example, AMAZON FIREHOSE®, installed on EC2 ephemeral servers may pick data, based on a particular engine and push it into AMAZON KINESIS STREAM®. An AMAZON KINESIS STREAM® may distribute the data to the different AMAZON KINESIS ANALYTICS® processors that may process and store the information accordingly. The orchestration of load tests may be carried out by, for example, AMAZON STEP FUNCTIONS®. States between different lambda invocations may be handled.

### Architecture Overview Embodiment

User Signs Up. The user points his/her browser to a designated platform URL. The URL downloads a single page app, served through a CDN and physically stored on a simple storage system. The User is asked to sign up, where different flavors are provided, among the classical form based, user can pickup to signup using an identity provider (for example GOOGLE®, AMAZON®, FACEBOOK® or SALESFORCE®). This user authentication and federation may be directly handled by a web service (for example, AMAZON COGNITO®). Once the user has signed up, the web service returns to the Single Page App an ephemeral token that the single page app may trade every time an API call is performed.

User Records a Test and Plays back a Test. Immediately after a user signup the user may be presented with the webpage the user wants to monitor, and some simple VCR like control overlay inviting him to start navigating over his/her website. This capability will be exposed using the InstaPlay recorder described above. In this way, the user may start recording on their webpage without installing anything and in a fully controlled environment.

Once they have recorded the script or during the recording process, the user may add validations to ensure that the right content is being served by the server as the user interacts with different parts of the application. The validations may be for the presence or absence of content, or may be for any arbitrary condition that the end user wants to check—and for this the user may be enabled to specify the condition to be met or not met using javascript, or the user may choose to validate the performance of a single step, a collection of steps or the entire script.

After the user is done recording, they may connect the script which is the output of the Instaplay recorder to external data sources like csv files, text files with data or data that is pulled from databases using an application.

The user may finish recording and then instantly play it back to ensure that the intent of the interaction against the application under test is captured. The user has the ability to save the script, give it a name and continue recording until they are done setting up the scripts required for the load test. The scripts may be stored in the Load Data Store and linked with the account. To save, open and store this script an API exposed through, for example, AMAZON GW® and stored as a Lambda Expression, may be invoked. The script may be stored on the database.

The platform has a notion of workspaces which contains projects. Projects represent artifacts associated with an application or an area of an application under test. Projects may contain the scripts for testing, scenarios which contain the configuration information for load tests and data from load test runs.

User Starts a Test. Projects may contain scenarios which contain configuration information such as, for example, maximum number of virtual users, ramp up period and profile amongst others. When the user is ready and a Start button is clicked, an API call may be invoked. This API may invoke a lambda function that will start a new business process instance. This business process instance is responsible for handling all infrastructural deployment and control required to start test, calculate the number of required EC2 instances, limits, etc.

When creating ephemeral load servers, using the versioned AMI, configuration variables may be provided as startup parameters, so the servers when started will know which load test to play. Each dedicated load test environment may be comprised of load generators, and by a single load executor. The load generators may register their browsers as a testing platform such as, for example, SELENIUM GRID®, that the load executor will use to execute the scripts. The scripts results may be handled by a real-time data streaming service that will push the data into the platform.

Linked to the data stream there may be an analytics module for analyzing the raw data and creating the metrics and cooked data to be stored in a database. A single page app may utilize an API to query in real time the results and render them accordingly on the user browser. The script result data is injected into a real time data stream. The raw data from the data stream is processed and injected to the database. In addition, the web application queries the data stream and renders the information to the user.

In generic terms, the script result data may be injected into the data stream. The raw data from the data stream may be processed by the analytics module through standard SQL and may injected to the database. In addition, the web application may query the data stream and render the information to the user.

In accordance with exemplary and non-limiting embodiments, the disclosed testing platform may be utilized as a SaaS offering and as an on premises service or as a private cloud service. The platform may be provided in front of or behind a firewall. In some instances, user interaction with the platform may occur in a pure web environment (plugin-less), wherein web transactions may be translated into load tests effectively.

In some exemplary embodiments, the architecture may be realized in a pluggable way where maps between script types and AMIs providing such a script capability are configured in the platform. In such instances, adding a new script type is a matter of creating a new EC2 Template as an AMI, and registering such a configuration in the database. In addition, the mapping may include the version as a third coordinate to allow capabilities bound to particular players.

In other exemplary embodiments, the platform may provide a gate to trial and test loads on applications behind the firewall. Employing a remote proxy component may enable trials from developers without requiring any other department involved, like the security department opening ports.

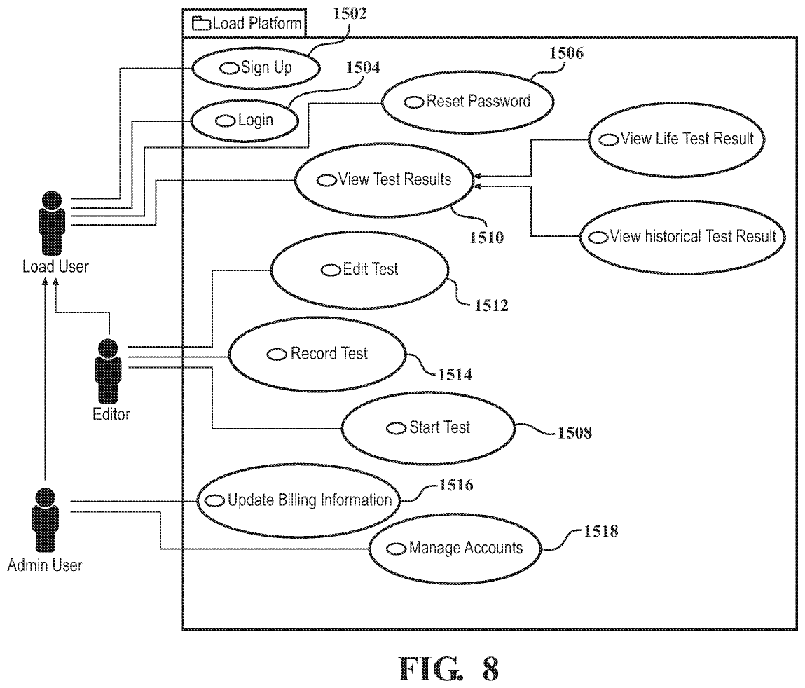

With reference to FIG. 8, there is illustrated an exemplary and non-limiting embodiment of architecturally significant use cases.

As illustrated in FIG. 8, exemplary descriptions of user use instances include the following:
Sign Up 1502: A user may sign up in the platform in a significantly effortless manner. Identity provider integration with standard IDP providers such as: GOOGLE®, FACEBOOK®, AMAZON®, or SALESFORCE® may allow users to sign up and login with a single click in a generally effortless manner.
Login 1504: Once user has signed up they will be able to log into the platform, either using the same mechanism it used to sign up or with a classical user/password combination they can pick up and modify at any time.
Reset Password 1506: User will be able to recover their password in case he/she signed up using a conventional form.
Start Test 1508: Editor users may be able to access the test repository and may be able to start a load test based on the selected test at any time. Users may be prompted about the particularities of the load test they want to start, among other parameters:
   Ramp Up Shape and period
   Max Virtual Users
   Test Duration
   Virtual User Behavior: “n” iterations or “1” iteration, “loop”
   Waiting Strategy:
      Random Gaussian timer
      Fixed time
Once a test has started, users may be sent to “Visualize Test Results” use case. One of the challenges with running load tests from the cloud is that the application under test is typically behind the firewall and not accessible from the outside world. Firewall rules are setup to prevent any inbound traffic emanating from the outside world to enter or go past towards internal networks. With cloud based load testing becoming popular, as it saves setting up 10 s or 100 s of virtual machines or servers, organizations typically get a list of IP addresses of the load generation machines and then ask the IT of security departments to temporarily allow traffic to be allowed to hit the application that is internally facing.
View Test Results 1510: Two different subcases similar in nature, but different in presentation, may be used depending on the status of the visualized test. If the test was completed, historical data may be presented and relevant information such as raw data gathering, charts, and error messages may be available. For ongoing tests, real time information may be exposed including, but not limited to, virtual users shaping, real time view of how the platform is behaving, etc.
Another element of viewing test results has to with comparing two results to see if one is better or not and in what way. Load Testing seeks to set up baselines so that subsequent runs of the same load test may serve to indicate if the application as it is being developed is improving or degrading from a performance perspective.
Edit Test 1512: Any user with Editor role may be able to edit recorded scripts. Users may be able to add or delete further steps on a recorded script, as well as add configuration options like data bags, or assertions.
Record Test 1514: Any user of the type Editor may be able to start a test recording. The input parameters for this use case is the URL of the website they want to start recording from. After the user has picked and typed the URL of the website, a browser inside its browser pointing to the given URL will be shown. This may be achieved by using a Recording Component provided by CBT. Users may navigate naturally inside the recorded web application. On the user's browser real time data describing the recorded steps may be provided. Once the user performs all the interactions they consider part of the load test, they may stop the test and the test may be saved into the test repository.
Start Test: Any user with a type Editor may be able to start an instance of a particular recorded test. The user may specify the number of virtual users, the ramp up profile, potential data bags, and any other run time test configuration options.
Update Information 1516: Any admin user may be able to update account related information, such as billing, payment method, etc.
Manage Accounts 1518: Any admin user may be able to manage subaccounts, create users, add and modify privileges and roles to them.

In addition to the systems and modules described herein and forming the load testing platform, the described platform may make use of various load generation subsystems comprising all of the virtual and physical entities that are responsible for generating load for a given test. As a result, the environment may be formed by the following sub modules:

1. Runner sub module: Used in most tests, as an automated testing facility needs to be run somewhere. The runner sub module may be responsible for running the actual test and report the results to a data ingestion module. More generically, a load test may be made up of a set of recorded interactions against the application under test that depict normal patterns of usage. Recorded interactions may be created using a recorder or using a testing framework. As used herein, “test interchangeably” refers to a load test that may have one or more scripts or recorded interactions.
2. Grid sub module: The Grid module may enable running multiple tests across different browsers, operating systems, and machines in parallel.
3. Browsers virtual machine: Browsers may be deployed in a virtual machine. This virtual machine may be created and destroyed by a Test Orchestrator subsystem. Every browser virtual machine, when started, registers all its browsers into its associated grid.
4. Test orchestration system: This system spins and controls every load test. Essentially it is a classical business process engine, where load tests are implemented as a single business process run.
5. Handle Test Business process: This process operates to decide the number of virtual machines to pre-allocate, handle any customer hard limits, provision the virtual machines, create the Grid module and Runner, etc. In addition to dealing with any specific load test particularity, such as specific load pattern, error and exception management, retries, etc.
6. Data ingestion subsystem: This subsystem digests the data flowing from tests and third party agents. Further data enhancement and computations are performed by this subsystem so reports and real status dashboards can be efficiently rendered.
7. Data Store Subsystem: This subsystem is responsible for storing all customer information, results, tests etc. and may comprise a highly scalable unstructured nosql database.
8. User Management subsystem: This module is responsible to store user data, provide authentication framework, and SSO experience with third party identified providers or corporate customers identity providers through Security Assertion Markup Language (SAML)
9. Back Office subsystem: All the logic required by the presentation layer interacting with the storage system may be covered by this platform. In a serverless paradigm, this may be implemented as spare pieces of that can be triggered by different platform events, or embodied as API with the API GW solution.
10. Web layer subsystem: This subsystem is responsible for materializing and distributing the user interface. It exposes and stores the front end web assets and provides a API driven GW to the services and logic required by the presentation UI as well as third party integrations.

The platform described herein may follow a serverless paradigm. Having no server provides advantages including (1) no specific role/team is required in the team to keep infrastructure, (2) pay truly as a service: if the load project has no customers, there will be no cost associated to it, and (3) virtually unlimited scalability.

While discussed with reference to load testing, the disclosure is not so limited. Rather the disclosure is broadly directed to any form of testing including, but not limited to (a) the functional testing of web applications (Functional testing is a quality assurance (QA) process and a type of black-box testing where a slice of functionality of the web application is tested by exercising it, based on requirements/specifications/user stories, as an end user would to see that it functions as designed) (b) testing the functionality of a web application for different browser types in what is called “Cross Browser Testing” where a recorded script may be played back against a different sets of browsers and (c) to ensure that mobile enabled web applications work correctly on mobile devices and different form factors (sizes and resolutions may vary as will be case when a user uses an iPad, mobile phone etc.)

The methods and systems described herein may be deployed in part or in whole through a machine that executes computer software, program codes, and/or instructions on a processor. References to a “processor,” “processing unit,” “processing facility,” “microprocessor,” “co-processor” or the like are meant to also encompass more that one of such items being used together. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be or include a frequency division multiple access (FDMA) network or a code division multiple access (CDMA) network. The cellular network may include mobile devices, cell sites, base stations, repeaters, antennas, towers, and the like. The cell network may be one or more of GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples but is to be understood in the broadest sense allowable by law.

What is claimed is:

1. A method comprising:
executing a web-based application within a first browser;
executing and displaying a second browser inside of the web-based application;
receiving, via the second browser, data indicative of one or more inputs comprising a browser session; and
recording and storing the one or more inputs on a computer readable medium.

2. The method of claim 1, further comprising utilizing the stored one or more inputs to simulate a load on a server.

3. The method of claim 2 wherein utilizing the stored one or more inputs comprises replaying the stored one or more inputs as inputs to the server at a predetermined scale.

4. The method of claim 3 wherein replaying the stored one or more inputs comprises running a plurality of browsers in a headless mode.

5. The method of claim 3, further comprising receiving an indication that replaying the stored one or more inputs has generated an error.

6. The method of claim 5, wherein, upon receiving the indication, replaying of the stored one or more inputs is suspended.

7. The method of claim 6, wherein replaying of the stored one or more inputs is suspended for a predetermined amount of time.

8. A method comprising:
recording and storing on a computer readable medium data indicative of one or more inputs comprising a browser session of a user executing on a client device;
replaying the stored one or more inputs as a plurality of virtual user sessions to a server at a predetermined scale sufficient to simulate a predefined number of virtual users based, at least in part, upon an existing server environment; and
inspecting, during the replaying of the one or more inputs, a single instance of one of the plurality of virtual user sessions.

9. The method of claim 8, wherein the inspecting comprises observing a graphical representation of a user interface of one of the plurality of virtual user sessions.

10. A system comprising:
a non-transient computer readable medium storing instructions that when executed by a processor cause the processor to:
execute a web-based application within a first browser;
execute and displaying a second browser inside of the web-based application;
receive, via the second browser, data indicative of one or more inputs comprising a browser session; and
record and store the one or more inputs on a computer readable medium.

11. The system of claim 10, wherein the processor is further configured to utilize the stored one or more inputs to simulate a load on a server.

12. The system of claim 11 wherein utilizing the stored one or more inputs comprises replaying the stored one or more inputs as inputs to the server at a predetermined scale.

13. The system of claim 12 wherein replaying the stored one or more inputs comprises running a plurality of browsers in a headless mode.

14. The system of claim 12, wherein the processor is further configured to receive an indication that replaying the stored one or more inputs has generated an error.

15. The system of claim 14, wherein, upon receiving the indication, replaying of the stored one or more inputs is suspended.

16. The system of claim 15, wherein replaying of the stored one or more inputs is suspended for a predetermined amount of time.

17. A system comprising:
a non-transient computer readable medium storing instructions that when executed by a processor cause the processor to:
record and store on a computer readable medium data indicative of one or more inputs comprising a browser session of a user executing on a client device;
replay the stored one or more inputs as a plurality of virtual user sessions to a server at a predetermined scale sufficient to simulate a predefined number of virtual users based, at least in part, upon an existing server environment; and
inspect, during the replaying of the one or more inputs, a single instance of one of the plurality of virtual user sessions.

18. The system of claim 17, wherein the inspecting comprises observing a graphical representation of a user interface of one of the plurality of virtual user sessions.
